(19) United States
(12) Patent Application Publication
(10) Pub. No.: US 2009/0259678 A1
(43) Pub. Date: Oct. 15, 2009

(54) BLUETOOTH VOLUME TRACKER

(76) Inventor: John Alcario VALENCIA, Tucson, AZ (US)

Correspondence Address: Saidman DesignLaw Group, 8601 Georgia Avenue, Suite 603, Silver Spring, MD, 20910, US

(21) Appl. No.: 12/101,704

(22) Filed: Apr. 11, 2008

(51) Int. Cl. G06F 17/30

(52) U.S. Cl. 707/102; 707/E17.009

(57) ABSTRACT

A method for tracking portable storage media paired with either a mainframe or a library. The portable storage media, mainframe, and library each having a short-range wireless communication device attached thereto such as Bluetooth™.

### BACKGROUND OF THE INVENTION

1. Field of the Invention

The present invention generally relates to a method and system for tracking or monitoring portable or removable data storage media, such as tape volumes using a short-range wireless technology, such as Bluetooth™. More particularly, the invention relates to software, hardware, systems, and methods for determining a physical location or other characteristics of portable or removable data storage media (e.g., metadata, which is data about data) when the storage media is transported or removed from a known location, and for tracking tape or other media volumes.

2. Description of the Related Art

Currently, in a tape library environment that has large storage requirements and subsequent data retrieval capability, such as the IBM 3490/3590 tape library (more specifically, 3494/3594), which is compatible with WORM (write-once, read-many) technology for regulatory compliance requirements, and the virtual tape server (VTS) technology, field customers working at a disaster recovery (DR) site or a production site often lose track of their tape or other media volumes. Disaster Recovery is a procedure for copying and storing essential business data for an installation in a secure location, and for recovering that data in the event of a catastrophic problem. Many disaster recovery policies require that backup copies of data be stored remotely on a tape volume or other media, and that a physically secure storage location be provided. Typical removable media can be a storage media widely used in the art such as magnetic tape, magnetic disk, optical tape, optical disk, solid state devices, holographic media, or the like. Removable storage media allows information to be periodically accessed, and when not in use, to be removed from a media library and placed in areas that may be on-site or off-site.

Losing track of a tape volume is caused because an end-user either manually removed a volume (the end-user opened an automated tape library (ATL) and physically pulled the volume out of its assigned slot) without the library ejecting the volume, or the volume is currently in an incorrect shelf location from the perspective of a mainframe (which tracks volumes by their slot location in the library) or in a remote location according to a manual tape management system. If the volume has been manually removed without library intervention, such as by ejecting the volume, then the library would still inventory the volume location as “volume resident,” and in an assigned slot within the library.

Because of these issues, the tape or media volume can be lost, or misplaced. With on-site misplacement a re-inventory of the library would be needed to update the library for all volumes in the mainframe, including their new and current locations. If the volume has been misplaced or lost on-site, then the end-user must locate the volume in order to enter the volume back into the system when it is requested.

In addition, if the tape or media volume has been sent off-site, then the volume is again only tracked by its current location. At a DR site, customers often arrive with their media or tape volume in a shipping container, such as a box or a bin, and thus, the volumes need to be manually entered into the mainframe via a media magazine with slots or grooves with a form factor matching the particular media such as a tape cartridge. An ATL allows an end-user to use system-managed storage for mountable tape cartridges. Mount requests for these cartridges are usually handled by a robotic tape cartridge handler capable of ejecting a volume. An ATL provides management facilities for tape volumes, but does not manage the data sets contained on those tape volumes.

A manual logging or scan of a bar code of each piece of media in a container is typically performed at an egress point and then, again as the shipping container is received at a destination. When a removable data storage media is removed from the ATL, its physical location is often only tracked with standard manual tracking techniques such as logging of serial numbers of the media with or without support of bar code scanners. Oftentimes when a customer does not have an accurate count of volumes or the correct identifying information of volumes a DR test cannot be efficiently or accurately run.

Within a tape library center, efforts have been made to track removable data storage media at a long-range distance. These techniques include using low frequency radio frequency identification (RFID) tags placed on the media, such as on a tape cartridge, and RFID readers within a media access device, such as a tape library, to wirelessly determine if the expected or correct media has been inserted in a read/write device. Bar code readers may also be used with tape libraries or other media access systems to track the location and to identify tape cartridges within the particular library. Both of these techniques require close proximity between the media cartridge and reader to be effective and are only useful within the library or media access system. However, such systems fail to provide verification of individual storage media.

These prior art techniques provide no confirmation of location or status and often only verify the existence of a container rather than individual media within the container.

### SUMMARY OF THE INVENTION

The present invention provides a method to overcome the disadvantages of prior art methods and systems. The present invention provides a system for better tracking the physical location and status of individual pieces of removable data storage media. Preferably such a system, and associated methods, would allow an operator to track the physical location of removable data storage media in a variety of domains or physical locales and would readily integrate with existing data management systems.

It is an object of the present invention to implement Bluetooth™ technology into a tape volume, mainframe, and an ATL to track volumes within the immediate vicinity of both the inside of the mainframe and the outside of the mainframe. Such tracking is not limited to the containers that store the removable storage media or to 3494/3594 tape library designs. The tracking disclosed in the present invention can be implemented anywhere that storage media is removable from a mainframe environment such as a stacked disk array or a direct access storage device (DASD), a device in which time is effectively independent of the location of the data.

The present invention provides a method for tracking portable storage media paired with one of a mainframe and a library, each of the storage media, mainframe, and library having a short-range wireless communication device attached thereto.

### BRIEF DESCRIPTION OF THE DRAWINGS

FIG. 1 is a flowchart of a method according to the invention.

### DETAILED DESCRIPTION OF EMBODIMENTS OF THE INVENTION

In the description that follows, numerous details are set forth in order to provide a thorough understanding of the present invention. It will be appreciated by those skilled in the art that variations of these specific details are possible while still achieving the results of the present invention. Well-known elements and processing steps are generally not described in detail in order to avoid unnecessarily obscuring the description of the present invention.

In the drawings accompanying the description that follows, often both reference numerals and legends (labels, text descriptions) may be used to identify elements. If legends are provided, they are intended merely as an aid to the reader, and should not in any way be interpreted as limiting.

The present invention provides a method and system for automatic/active (battery-powered) and/or passive (battery-less) tracking the location of removable storage volumes using a short-range wireless technology, such as Bluetooth™ (and corresponding software and hardware components) in a tape volume, and mainframe, and an ATL, and, in some cases, providing a status of removable media even when it is not in a tape library. More specifically, as shown below, the invention includes a method for tracking portable storage media paired with either a mainframe or a library. Each of the portable storage media, mainframe, and library having a short-range wireless communication device attached thereto.

Bluetooth™ technology allows for two devices in close proximity of each other to interface with one another without physical intervention. These devices only need to be in the vicinity of one another to recognize each other. This wireless technology already enables devices such as portable computers, cell phones, and portable handheld devices, for example, to connect to each other and also to the Internet. As this pertains to a 3494/3595 tape library and a mainframe environment, the removable media does not have to be in the library and read in order for the wireless technology to access the tape volume.

This invention exploits Bluetooth™ technology even further. This type of wireless technology can be used between powered devices and the Bluetooth™ technology is integrated into the design of the tape/media itself as well as into the mainframe/ATL to track the location of built-in storage media.

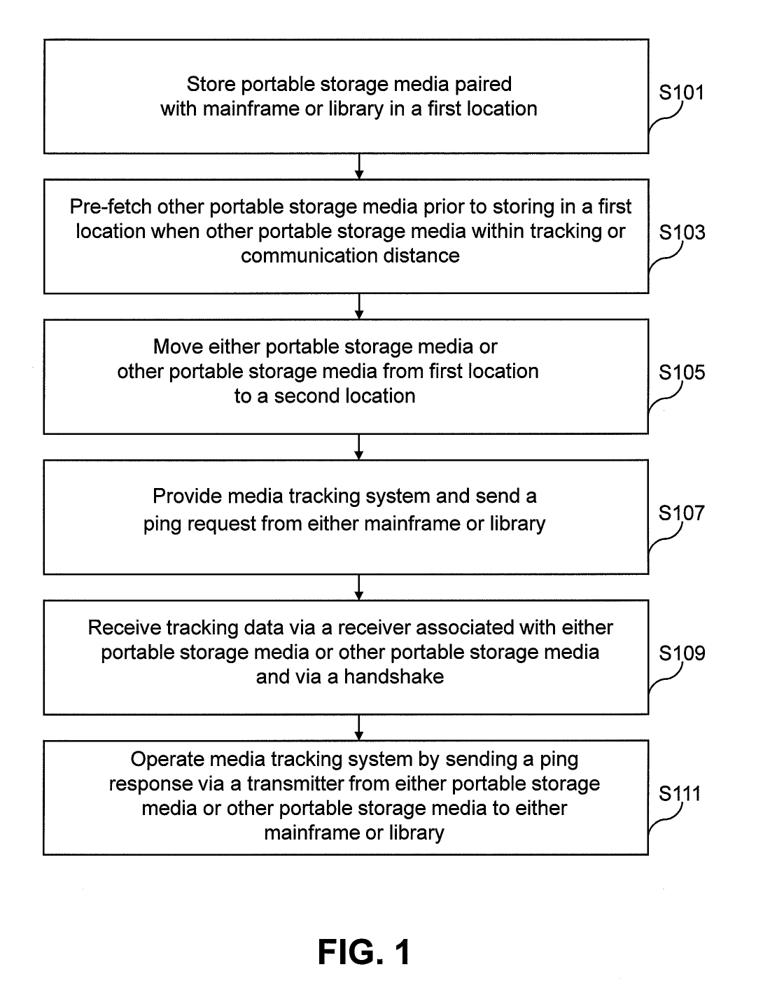

FIG. 1 is a representative flowchart describing a method of the invention.

When available (in close proximity) and working, a Bluetooth™ chip in a paired device (two devices associated with one another), either the volume and the library or the volume and the mainframe (S101), for example, allows for a transfer of data to validate the presence of the media/tape volume in the immediate area (S105). A basic set of data is transmitted in a form of a handshake (an automated process of negotiation that dynamically sets parameters of a communications channel established between two devices before normal communication over the channel begins) to transfer data to the mainframe about a tape volume located outside a mainframe. This data may include basic volume serial number (VOLSER) information, such as owner information, component information, use category of the volume (scratch or private), number of datasets, object-format data, and the like. The ATL is also able to track the location of a volume inside a mainframe.

A transmitter or Bluetooth™ chip in the ATL/mainframe would ping out a request (self test a network interface card of the server computer, S107) to any tape volume and the tape volume would then respond to, or also ping out or response to the ATL/mainframe that it is available or in close proximity (S111), and again, then a basic set of data is transmitted in a form of a handshake with all the generic information needed (S109). Once the volume is in the library, the status of the volume can be changed to be in the library on a receiver or Bluetooth™ chip in the media volume. The library would already be physically involved to handle the volume and know that the volume is in the library, for example.

The media can be tracked using wireless metadata transmitters/receivers placed on each storage media and wireless metadata receivers/transmitters to report location data and metadata for the media to a media tracking system and its location processor. Briefly, a removable data storage media tracking system is provided that includes removable media that has an internal or external transmitter/receiver storing a unique ID and system generated data (e.g., volume serial number and/or other metadata).

If the volume is not within a tracking radius, then the ATL/mainframe would only ping out and read volumes that are available. The ATL/mainframe can ascertain that the volume is remote if the tape management system has a record of the off-site location of the volume. Only volumes within the tracking radius are communicated with and can be recorded as “volume resident.” Volumes outside the tracking radius can be recorded as “volume not-resident.”

The present invention includes a benefit of better inventory management of volumes in the library, outside the library in the immediate area, and volumes outside of the immediate area. This would enhance volume tracking and management of volumes.

Another benefit of the present invention is the ability to pre-fetch volumes. Volumes brought into the area would be sought out by the ATL/mainframe by sending a ping request and basic information could be pre-loaded into the ATL inventory (S103).

An embodiment described above implements a design of the media/tape to have a powered/awakening function to transmit and receive data. Possible other designs include other constant/actively powered sources (battery or charger), a docking station, or a passive (battery-less) method, and the like, to interface with the library. Each data storage media in a system may include a wireless transmitter with memory for storing a set of metadata, e.g., ID, status, destination, or the like. The wireless transmitter does not typically include a power source but, instead, is typically configured to be powered or awakened when it receives an RF signal (such as with an antenna not shown) and can then transmit the contents of its memory, in other words, to transmit metadata to a receiver. Also, the transmitter is configured for the metadata to be updated or written by a locator/receiver of the system to allow status, usage history, or the like to be modified.

To practice the invention, a tracking system can include a computer and networked devices, such as those used to form an enterprise system or customer enterprise, and may be any devices useful for providing the described functions, including well-known data processing and storage and communication devices and systems with processing, memory, and input/output such as I/O ports, and server devices configured to maintain and then transmit digital data over a wireless communications network.

The wireless communication may be based on other short-range wireless communication technologies other than Bluetooth™, such as microwave, shortwave, wireless fidelity (Wi-Fi), IrDA, Home RF and IEEE 802.11, or the like. Further, the communication may be wireless such as for those that are mobile, and to this end, each locator/receiver typically includes a communication module (e.g., a cellular or satellite based communication module) and this or another module is also typically used to receive location data from a satellite-based, cellular-based, or other location system (such as the Global Positioning System (GPS), the GLONASS system, or systems using cell phone technologies). In some embodiments, the communication modules utilized are GSM/GPRS modules or modems but other communication/location modules may be used to practice the invention. Two-way communication between a management or tracking application and the removable media is available in most embodiments of the invention to allow direct manipulation of the data and management of the media.

While the invention has been described in terms of disclosed embodiments, those skilled in the art will recognize that the invention can be practiced with modification within the spirit and scope of the appended claims.

1. Method for tracking portable storage media paired with one of a mainframe and a library, each of the portable storage media, mainframe, and library having a short-range wireless communication device attached thereto, comprising:
storing a first portable storage media which is Bluetooth™-paired with one of the mainframe and library in a first location;
providing a media tracking system which is communicatively associated with portable storage media and which manages location determination;
pre-fetching a second portable storage media prior to storing in a first location by pre-loading the second portable storage media into an inventory memory of one of the mainframe and library and propagating location information when the second portable storage media is within a tracking or communication distance, wherein the pre-fetching includes sending a ping request from the media tracking system;
moving one of the first portable storage media and the second portable storage media from the first location to a second location;
accessing tracking data via a receiver associated with one of the first portable storage media and the second portable storage media, the tracking data including location information, and the tracking data being transmitted via a handshake; and
operating the media tracking system to manage a location of the second portable storage media based on the received tracking data by sending a ping response via a transmitter associated with the second portable storage media.
